(19) United States
(12) Patent Application Publication
(10) Pub. No.: US 2008/0225846 A1
(43) Pub. Date: Sep. 18, 2008

(54) Methods and Apparatus for Transmitting Data in a Packet Network

(75) Inventors: Dimitri Kanevsky, Ossining, NY (US); Stephane Herman Maes, Danbury, CT (US); Alexander Zlatsin, Yorktown Heights, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/127,957

(22) Filed: May 28, 2008

Related U.S. Application Data
(63) Continuation of application No. 11/779,973, filed on Jul. 19, 2007.
Application No. 11/779,973 is a continuation of application No. 09/558,372, filed on Apr. 26, 2000, now abandoned.

(51) Int. Cl. H04L 12/56

(52) U.S. Cl. 370/389

(57) ABSTRACT

Methods and apparatus are disclosed for transmitting data, such as biometric data or Internet telephone data, in a packet network Packets are split and interchanged prior to transmission across a packet network, such that packets that reach their destination may be processed, even in the presence of lost or delayed packets. Packets of biometric data, such as fingerprints, retinal scans or voice characteristics, or sampled voice packets are split, and optionally interchanged prior to transmission If some packets are lost or delayed, while some of the packets reach their destination and provide sufficient data for user identification, then the user may be authenticated without requesting the retransmission of the lost or delayed data If some packets are lost or delayed, while some packets reach their destination, then the received speech samples may be reproduced without requesting the retransmission of the lost or delayed data

### CROSS REFERENCE TO RELATED APPLICATIONS

This application is a continuation of U.S. patent application Ser. No. 11/779,973, filed on Jul. 19, 2007, which is a continuation of U.S. patent application Ser. No. 09/558,372, filed on Apr. 26, 2000, incorporated by reference herein.

### FIELD OF THE INVENTION

The present invention relates generally to packet transmission techniques, and more particularly, to a method and apparatus for transforming packets, such as packets of biometric data, for efficient transmission over a network.

### BACKGROUND OF THE INVENTION

A communication network transfers information, such as data, voice, text or video information, among various devices connected to the network, such as telephones and computers. Information transmitted over a network is often formatted into packets or cells. Packet networks, such as networks using the Internet Protocol (IP), where transmitted data is divided into packets, are widely used. Packets reach their destination by traversing through one or more network elements, such as switches or routers. Packets typically include a header containing, for example, a source address and a destination address, as well as the actual data.

Various forms of data are increasingly distributed over the public Internet and other packet networks. In particular, packet networks are increasingly being utilized by data intensive applications to carry various forms of data, such as voice telephone traffic, using protocols such as the well-known H.323 protocol, and biometric data that is transmitted to confirm or obtain the identity of a person requesting access to a restricted service, device or location. For example, a number of access control mechanisms evaluate biometric information, such as fingerprints, retinal scans or voice characteristics. For a more detailed discussion of such biometric-based access control systems, see, for example, U.S. Pat. No. 5,897,616, entitled “Apparatus and Methods for Speaker Verification/Identification/Classification Employing Non-Acoustic and/or Acoustic Models and Databases,” U.S. patent application Ser. No. 09/008,122, filed Jan. 16, 1998, entitled “A Portable Information and Transaction Processing System and Method Utilizing Biometric Authorization and Digital Certificate Security,” and U.S. patent application Ser. No. 09/417,645, filed Oct. 14, 1999, entitled “System and Method for Providing Secure Financial Transactions,” each assigned to the assignee of the present invention and incorporated by reference herein.

A number of protocols have been developed to facilitate the transmission of data over a packet network. For a detailed discussion of many such network protocols, see, for example, W. Richard Stevens, UNIX Network Programming (Prentice-Hall, 1990), incorporated by reference herein. The Transmission Control Protocol (TCP) is one protocol used with the well-known Internet Protocol (IP) to send data over the Internet. While the IP protocol handles the actual delivery of the data, the TCP protocol keeps track of the individual packets within a message for efficient routing through the Internet.

For example, when a hypertext markup language (HTML) file is sent from a Web server to a client (user), the TCP program layer in the server divides the file into one or more numbered packets, and then forwards the packets individually to the IP program layer. Although each packet has the same destination IP address, a given packet may get routed differently through the network. At the receiving end (the client program in the user's computer), the TCP program layer reassembles the individual packets and waits until they have arrived before forwarding them as a single file.

The TCP protocol is a connection-oriented protocol. Thus, a connection is established and maintained until such time as the message or messages to be exchanged by the application programs at each end have been exchanged. TCP is responsible for ensuring that a message is divided into the packets managed by the IP layer and for reassembling the packets back into the complete message at the receiving end.

The User Datagram Protocol (UDP) is another communications protocol that offers a limited amount of service when messages are exchanged between computers in a packet network using the Internet Protocol (IP) The UDP protocol is generally faster than the TCP protocol since the UDP protocol does not wait for all the packets to arrive at a destination point before processing the data Failing to wait for all the packets, however, often causes delayed packets to be effectively lost. Like the TCP protocol, the UDP protocol uses the IP protocol to actually get a data unit (a packet) from one computer to another. Unlike the TCP protocol, however, the UDP protocol does not provide the service of dividing a message into packets and reassembling the packets at the receiving end. Thus, an application program that uses the UDP protocol must ensure that the entire message has arrived and is in the proper sequence The UDP protocol provides port numbers to help distinguish different user requests and optionally provides a checksum capability to verify that the data arrived intact.

In packet networks, a congestion management policy is required to ensure that sufficient network resources are available in the network to handle the signaling and control of the call. Since individual packets within a message can travel over various routes between a given source and destination, individual packets may be lost or delayed if there is sufficient traffic volume or service interruption along any one such route Depending on the nature of a given application and the transmission protocols utilized, the loss or delay of one or mote packets may be remedied using interpolation techniques to approximate the lost data, or may require the entire message to be retransmitted.

Biometric data that is transmitted to confirm or obtain the identity of a person requesting access to a restricted service, device or location, for example, may be particularly intolerant of such lost or delayed packets Typically, following the loss or significant delay of packets, the authentication system must request the user to repeat the authentication process, thereby consuming additional time and network resources. When the authentication is performed in connection with a financial transaction, for example, the loss or significant delay of packets may cause transactions to be missed, incomplete or incorrectly completed, especially at times of peak network traffic. Furthermore, such delays in executing a financial transaction may cause a change in price or product availability by the time the transaction is ultimately completed.

A need therefore exists for an improved method and apparatus for transmitting data in a packet network.

### SUMMARY OF THE INVENTION

Generally, methods and apparatus are disclosed for transmitting data, such as biometric data or Internet telephone data, in a packet network. The present invention splits and interchanges packets transmitted across a packet network, such that packets that reach their destination may be processed, even in the presence of lost or delayed packets.

In an illustrative biometric embodiment, packets of biometric data, such as fingerprints, retinal scans or voice characteristics, are split, and optionally interchanged prior to transmission. In this manner, if some of the packets are lost or delayed, while some of the packets reach their destination and provided sufficient data for user identification, then the user may be authenticated without requesting the retransmission of the lost or delayed data. Similarly, for the case of packet telephone data, the sampled voice packets are split, and optionally interchanged prior to transmission. In this manner, if some of the packets are lost or delayed, while some of the packets leach their destination, then the received speech samples may be reproduced without requesting the retransmission of the lost or delayed data.

A packet splitter splits framed data into a number of packets. In the illustrative embodiment, the framed data is split into two packets with the first packet containing k frames having odd indexes: f₁, f₃, . . . f₍₂ₖ₊₁₎ and the second packet having k frames having even indexes f₂, f₄, . . . f₂ₖ If both packets arrive at a destination point, they can be integrated back into the framed data comprised of the continuous string of frames, f₁, f₂, f₃, . . . , f_{N} Otherwise, if a packet was lost or significantly delayed, the data can be recovered from the single received packet using, for example, smoothing techniques, such as spline extrapolation, for the lost packets with even indexing.

In a further variation, the packet data may be split and interchanged such that compressed biometrics information for two subsequent packets, S1 and S2 is reorganized. Generally, half of packet S1, referred to as S1a, is switched with half of packet S2, referred to as S2a, before transmitting the data. S1a consists of every other frame of digitized voice signal. The second half of S1, referred to as S1b, consists of all the remaining frames of S1 that are not in S1a. S2 is split into two parts, S2a and S2b, in a similar manner. After switching S1a with S2a, two new packets are produced, where packet P1 contains parts S2a and S1b and packet P2 contains parts S1a and S2b. The new packets P1 and P2 are sent over the network 110 instead of S1, S2. If at a destination point, both packets P1 and P2 arrive, the packets P1 and P2 will be reconstructed to form packets S1 and S2 from P1 and P2 by switching S1a and S2a. If only one packet, such as packet P1, arrives, then the content of packet P1 will be split in two packets and loss information will be extrapolated. In this manner, only some reduction in voice quality will happen instead of full loss of information.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 illustrates a packet splitter that may be utilized by a source server of FIG. 1, in accordance with the present invention;

FIGS. 3A through 3D illustrate various representative biometric portions, applicable to one embodiment of the present invention;

FIG. 4 illustrates the splitting of biometric portions, in accordance with one embodiment of the present invention;

FIG. 5 is a schematic block diagram of a biometric integrator that may be utilized by a destination server of FIG. 1, in accordance with the present invention;

FIG. 6 is a schematic block diagram of an integrator that may be utilized by a destination server of FIG. 1, in accordance with the present invention; and

FIG. 7 is a flow chart describing a packet splitting process in accordance with the present invention.

### DETAILED DESCRIPTION OF PREFERRED EMBODIMENTS

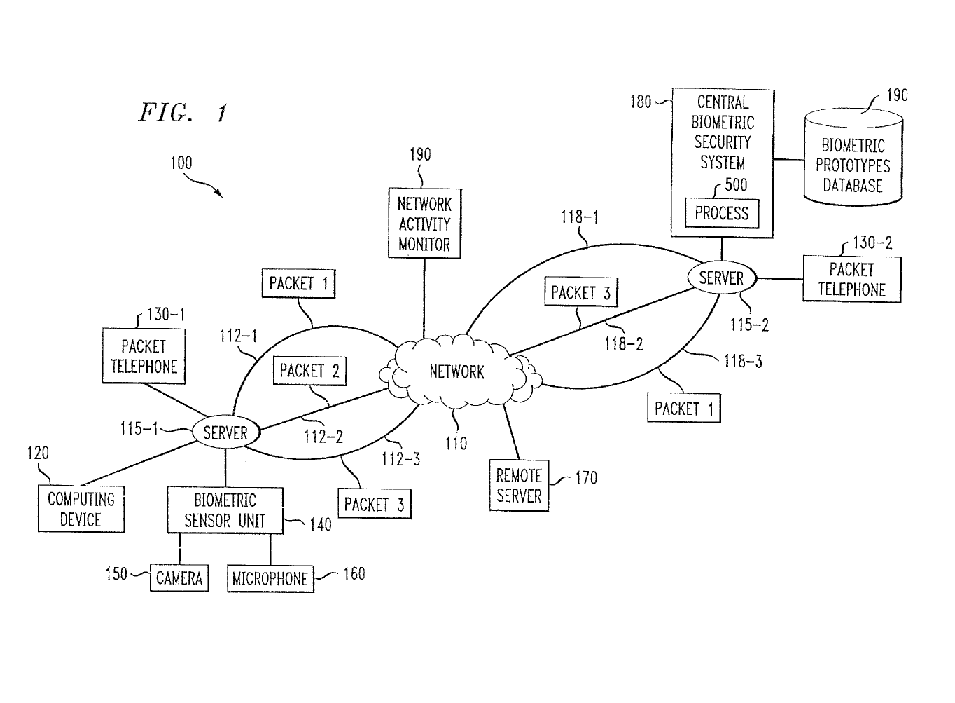

FIG. 1 illustrates a network environment 100 in which the present invention can operate. According to one feature of the present invention, packets that are transmitted across the network 110 are split and interchanged, such that packets that reach their destination may be processed, even in the presence of lost or delayed packets While the present invention may be applied to any information transmitted over a packet network, the invention is illustrated herein using Internet telephone and biometric data as examples.

In the case of biometric data, such as fingerprints, retinal scans or voice characteristics, the biometric data packets are split, and optionally interchanged prior to transmission. In this manner, if some of the packets are lost or delayed, while some of the packets reach their destination and provided sufficient data for user identification, then the user may be authenticated without requesting the retransmission of the lost or delayed data. The present invention recognizes, for example, that a frame-by-frame speaker recognition system can directly be performed on portions of the biometric data.

Similarly, for the case of packet telephone data, the sampled voice packets are split, and optionally interchanged prior to transmission In this manner, if some of the packets are lost or delayed, while some of the packets reach their destination, then the received speech samples may be reproduced without requesting the retransmission of the lost or delayed data.

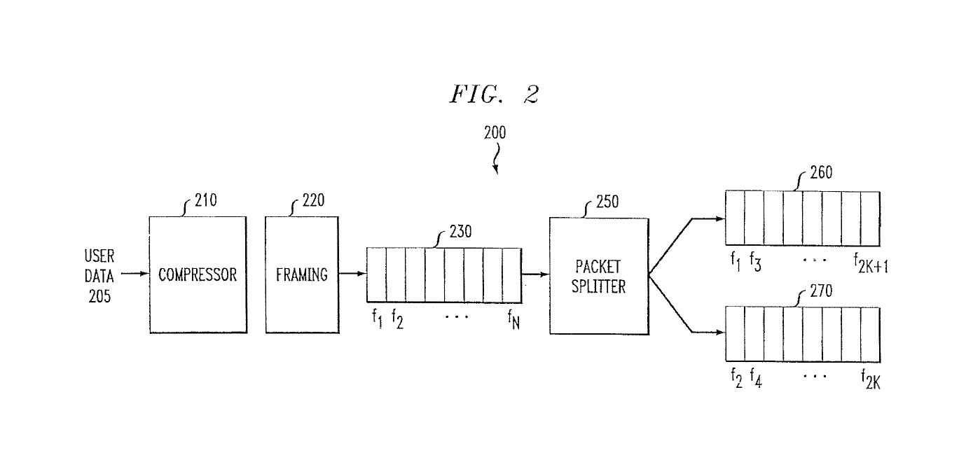

In one embodiment shown in FIG. 1, a first packet telephone 130-1 communicates over the packet network 110 with a second packet telephone 130-2. As previously indicated, the voice communications may conform, for example, to the H.323 protocol. As discussed further below in conjunction with FIG. 2, the voice packets are split and optionally interchanged in accordance with the present invention. When a user calls over the network 110, such as the Internet, using a packet telephone 130-1 to a destination packet telephone 130-2, the voice telephone data is received by a server 115-1. The voice data is split into packets 1-3 by a packet splitter (not shown in FIG. 1), discussed further below in conjunction with FIG. 2, each routed by the server 115-1 along separate paths 112-1 through 112-3. Thereafter, the network 110 delivers the packets 1-3 to the server 115-2 associated with the destination device 130-2 using separate paths 118-1 through 118-3. As shown in FIG. 1, if one of the packets, such as packet 2, does not reach the destination device 130-2, the destination device 130-2 can still reproduce the received voice data associated with packets 1 and 3 for the user. The quality of the telephone data received at the destination device 130-2 degrades insignificantly despite the loss of one or more packets.

In one embodiment shown in FIG. 1, a central biometric security system 180 restricts the ability of a user operating a computing device 120 to access a device, such as a server 170, that is connected to the network 110. It is noted that while the illustrative embodiment of the present invention utilizes a remote biometric security system 180 to restrict access to a remote device 170, the present invention can likewise be applied to restrict access to a local device 170, or to a local secure facility or service, as would be apparent to a person of ordinary skill in the art

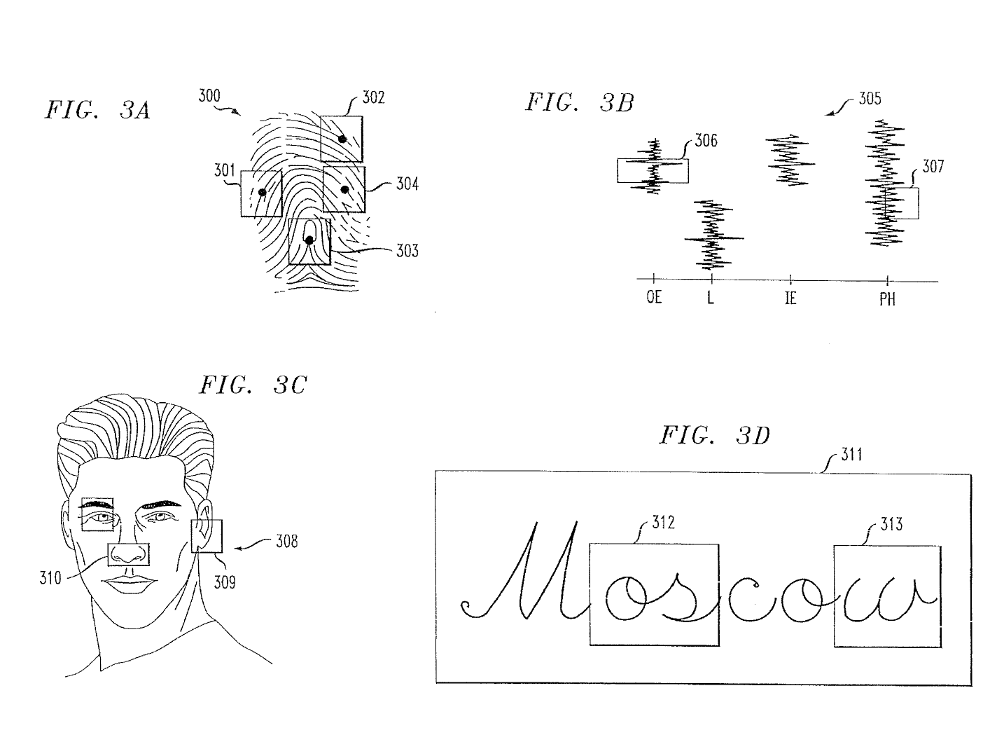

The biometric security system 180 uses biometric data about the user, obtained, for example, from a biometric sensor unit 140, to verify the identity of the user. According to a feature of the present invention, discussed further below in conjunction with FIG. 3, the biometric data is split and optionally interchanged in accordance with the present invention. In this manner, only a portion of the biometric data may be used to validate the user's identity. For a more detailed discussion of biometric portions, see U.S. patent application Ser. No. 09/467,581, filed Dec. 20, 1999, entitled “Methods and Apparatus for Restricting Access of a User Using Random Partial Biometrics,” assigned to the assignee of the present invention and incorporated by reference herein.

The partial biometrics data is provided to the server 115-1 and split into packets by a splitter (not shown in FIG. 1), discussed further below in conjunction with FIG. 2. Each packet is routed by the server 115-1 along separate paths 112-1 through 112-3 Thereafter, the network 110 delivers the packets 1-3 to the server 115-2 associated with the central biometric system 180 using separate paths 118-1 through 118-3. As shown in FIG. 1, if one of the packets, such as packet 2, does not reach the central biometric system 180, the central biometric system 180 can still process the received biometric data associated with packets 1 and 3 to identify the user. The quality of the biometric data received at the destination device 130-2 degrades insignificantly despite the loss of one or more packets.

The user biometric data is obtained, for example, from a camera 150 or microphone 160. While the biometric sensor unit 140 is shown as a separate device from the computing device 120, the biometric sensor unit 140 could be integrated in a single device with the computing device 120. The user biometric data can include fingerprints, voice characteristics, facial characteristics, handwriting characteristics, tissue characteristics, gestures and any other known biometric data A biometric prototype database 190 records a biometric prototype for each registered user, in a known manner

According to one feature of the present invention, a portion of the digitized user biometric data is sent to the central biometric security system 180 using separate packets to validate the identity of the user. The portion of the digitized user biometric data can include a portion of a digitized image, for example, when the biometric data consists of a fingerprint, facial characteristic or handwriting characteristic, or a portion of speech segments when the biometric data consists of voice characteristics. Network resources are conserved, since only a portion of the original biometric image is transmitted, and encryption is not required.

In one implementation, discussed further below, the central biometric security system 180 transmits a request to the biometric sensor unit 140 containing a sequence of random coordinate pairs corresponding to portions of the digitized image of the biometric information. In an alternate implementation, the central biometric security system 180 can request the biometric portion by specifying a particular feature of the digitized image of the biometric information. For example, the central biometric security system 180 can request specific features or regions to be dynamically determined, such as identified portions of a user's face (i.e., region around the lips or eyes) when the biometric data consists of images or video or identified portions of speech, for example, using word-order, when the biometric data consists of speech

The biometric sensor unit 140 obtains the full biometric image, and extracts the content of pixels from the full image only at the identified coordinates (or features) for transmission to the central biometric security system 180. For example, for each pixel, the biometric sensor unit 140 can determine whether the pixel has a binary logic value of zero (0) or one (1). The manner in which the biometric portions are configured into packets for transmission is discussed in conjunction with FIG. 3. The central biometric security system 180 compares the received portions of the full biometric image with the corresponding portions of the biometric prototype stored in the biometric prototype database 190 for this user. The user is permitted to access the requested device 170 if the biometric portions match.

A user operating a computing device 120 sends a request to access a remote server 170 over the network 110. The present invention can also be applied to restrict the user's access to the computing device 120 itself The user request activates the central biometric security system 180 to identify (or verify the identity of) the user.

The central biometric security system 180 compares the received samples of user biometric portions with the corresponding user prototype biometric portions and allows the user to access the requested remote device 170 if the received user biometric portions match the user prototype biometric portions. It is noted that the central biometric security system 180 can export the comparison task to another server, such as sensor unit 140 or server 190, in the network environment 100.

As shown in FIG. 1, the network environment 100 may also include a network activity monitor 190 to evaluate the amount of traffic on the network 110, preferably in real-time The monitor 190 summarizes the data on network activity, such as volumes and speed of transactions in the network 110. The network traffic data may also indicate the traffic on each path, such as paths 112 and 118

### Splitting Packet Data

FIG. 2 is a block diagram of a splitter 200 that is used by a server, such as the server 115-1, to split packets and optionally interchange packets in accordance with the present invention. As shown in FIG. 2, the splitter 200 includes a compressor 210 for compressing received data 205, a framing block 220 for converting the compressed data into a frame representation 230 and a packet splitter 250 for splitting and optionally inter changing packets in accordance with the present invention

The compressor 210 may compress the data 205, such as pulse-code-modulated (PCM) voice data, into cepstra See, for example, Jerome R Bellegarda, “Context-Dependent Vector Clustering for Speech Recognition”, Automatic Speech and Speaker Recognition, 133-153 (Kluwer academic Publishers, C-H Lee & F K Song eds, 1996.

Compressed data usually is represented as frames, where small amounts of data were captured at some time interval. For example, cepstra is related to some vector of amount of energies at different frequency bands acquired at regular time intervals. Another example of a frame can be related to a representation of data using wavelet techniques. In this approach, data is represented as a sum of wavelets with weighted coefficients In the example of FIG. 2, frames at different time intervals t₁, t₂, t₃, . . . t_{N} are labeled as f₁, f₂, f₃, . . . , f_{N}.

The packet splitter 250 splits the framed data 230 into packets, such as packets 260, 270 It is assumed that a typical packet 260, 270 consists of k frames. For example, as shown in FIG. 2, the first packet 260 may consist of k frames having odd indexes: f₁, f₃, . . . f₍₂ₖ₊₁₎ and the second packet 270 may consist of k frames having even indexes f₂, f₄, . . . f₂ₖ.

If both packets 260 and 270 arrive at a destination point, they can be integrated back into the framed data 230 comprised of the continuous string of frames, f₁, f₂, f₃, . . . , f_{N} Otherwise, if a packet, such as packet 270, was lost or significantly delayed, the data can be recovered from the single received packet 260 using, for example, smoothing techniques, such as spline extrapolation, discussed below, for the lost packets with even indexing

In a further variation, the packet data may be split and interchanged such that compressed biometrics information for two subsequent packets, S1 and S2 is reorganized. Generally, half of packet S1, referred to as S1a, is switched with half of packet S2, referred to as S2a, before transmitting the data. S1a consists of every other frame of digitized voice signal. The second half of S1, referred to as S1b, consists of all the remaining frames of S1 that are not in S1a. S2 is split into two parts, S2a and S2b, in a similar manner After switching S1a with S2a, two new packets are produced, where packet P1 contains parts S2a and S1b and packet P2 contains parts S1a and S2b. The new packets P1 and P2 are sent over the network 110 instead of S1, S2 If at a destination point, both packets P1 and P2 arrive, the packets P1 and P2 will be reconstructed to form packets S1 and S2 from P1 and P2 by switching S1a and S2a.

If, on the other hand, only one packet, such as packet P1, arrives, then the content of packet P1 will be split in two packets and loss information will be extrapolated In this manner, only some reduction in voice quality will happen instead of full loss of information

It is assumed that the audio-signal has a variable gradient. The gradient for a given audio data segment may change slowly or fast. When the gradient is slowly changing, an original voice data segment can be recovered when it is sampled at low rates. In the case of voice data for a speaker recognition system, it can be assumed that speaker data is represented as cepstra N consecutive packets, where N is greater than 2, are represented as S₁, S₂, . . . S_{N}. Each packet is split into N sub-packets consisting of sub-samples (taken from N sub-samples of an original sample). These sub-packets can then be switched in a similar manner as sub-packets for the case discussed above where each packet was split into two packets (N=2) and new mixed packets would be created. This allows the recovery of the audio signal if a higher percentage of packets is lost. When the gradient is changing fast, the packet is copied, rather than split, and several identical copies of a packet are sent This redundancy compensates for the loss of some packets

As discussed further below, the packet splitter 250 may employ an algorithm that receives as input the data rate available between the sender and receiver as well as the dominant frequency content and cost functions imposed by the application

At any time, the amount of buffered data to expedite and the cost of losing this data are estimated to decide between splitting among two or more packets or repeating some packets Obviously, binary data requires repeating the data, but may wait for a request to retransmit a missing packet from the receiver. Voice can be temporarily down sampled based on the traffic

Furthermore, the way that the information is split into S1a and S1b can be different than simply by down sampling. Perfect (or quasi-perfect) reconstruction subband coding or wavelet representation may be utilized, thereby directly taking the frequency content into account. Also, it is more directly compressed by classical coding techniques. The advantage of a multi-resolution technique, such as wavelets, is that if you now split up the signal into N components, you can determine the dominant component to send (and possibly repeat) then add details for which it is less important to appropriately transmit them. Not only does it guarantee that the packets are received on the other end, but it also guarantees that the most important packets will arrive in a timely manner Thus, even if all details do not arrive immediately, enough information is sent to reconstruct the packet. Indeed, besides packet losses, packet delays are another major concern.

Similarly, voice data associated, for example, with Internet telephone services, can be split and reorganized. The voice telephone data may be represented as cepstra. The cepstra can be split into packets in a similar manner as described above for biometrics data. The quality of the audio data that is recovered from cepstra will degrade insignificantly if one takes out every second frame from cepstra (and replaces them with some extrapolations).

If a user requests access to some service, device or facility via server 115-1, the biometrics sensing unit 140, such as a camera, fingerprint scanner or microphone, will capture user biometric data, such as a face image, fingerprint or voice prints. The captured biometrics data is used by the splitter 250 to determine what kind of packet splitting to perform in accordance with the present invention.

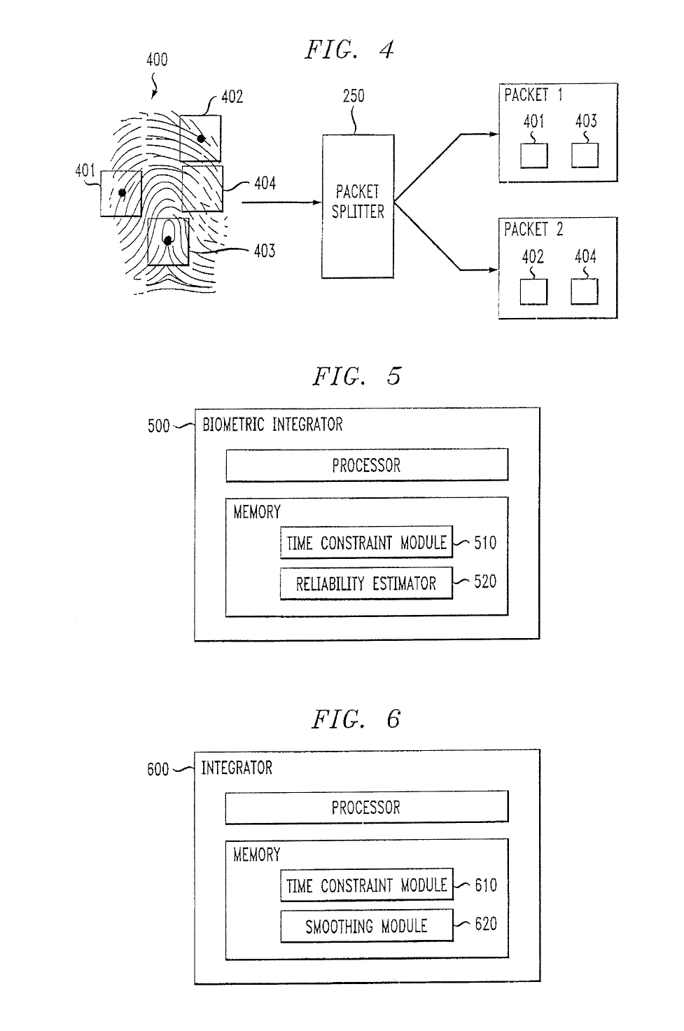

At times of low network traffic, for example, the biometrics data may be transmitted using standard Internet protocols, such as the TCP protocol discussed above. At times of moderate network congestion, the packet splitter 250 may reorganize the biometric data before splitting the data into packets, as discussed above in conjunction with FIGS. 2 and 4 At times of heavy network congestion, the packet splitter 250 may distribute a unique biometrics portion, such as packet 1 in FIG. 4, among more than 2 packets. Generally, there is an inverse relationship between network traffic conditions and the recommended number of packets used for transmission

### Splitting Biometric Portions

FIG. 3A illustrates representative biometric portions 301-304 of a fingerprint 300. As shown in FIG. 3A, each part 301-304 of a fingerprint 300 is a small rectangular portion of the larger image 300. As shown in FIG. 3B, biometric portions can include sound sub-units that are represented as areas OE 306, and PH 307 of a spectogram 305, for a sequence of phones OE, L, IE, PH. In addition, biometric portions can include sound sub-units of a given speech phone, such as phone PH 307. For example, a sub-unit of a phone can include portions of a given phone or the whole cepstral feature vector within a phone. As shown in FIG. 3C, biometric portions can include parts 309-310 of a face picture 308. In addition, as shown in FIG. 3D, biometric portions can include parts 312, 313 of a written phrase 311. In alternate embodiments, biometric portions can also include parts of a picture of an eye, parts of spoken phrases, represented as PCM data, parts of cepstra and parts of gestures. As previously indicated, the biometric portion can be explicitly specified by the central biometric security system 180, for example, by specifying certain pixels to include in the biometric portion, or can be dynamically determined, for example, by specifying certain features, such as lips or eyes, to include in the biometric portion.

FIG. 4 illustrates how biometrics data, such as a fingerprint 400, can be split into packets in such a way that each packet contains partial biometrics. As shown in FIG. 4, biometric portions 401-404 of a fingerprint 400 can be applied to the packet splitter 250, discussed above in conjunction with FIG. 2. The packet splitter 250 generates two packets 1, 2. The first packet contains biometric portions 401, 403 and the second packet contains biometric portions 402, 404. The number of packets generated by the packet splitter 250 can vary depending on the required quality and on network conditions. At times of peak network traffic, for example, then the number of packets into which the partial biometrics are split can be increased.

For a discussion of techniques of obtaining user biometrics, see, for example, U.S. Pat. No. 5,895,447, entitled “Speech Recognition Using Thresholded Speaker Class Model Selection or Model Adaptation,” U.S. patent application Ser. No. 08/788,471, filed Jan. 28, 1997, entitled “Text Independent Speaker Recognition for Transparent Command Ambiguity Resolution and Continuous Access Control,” U.S. patent application Ser. No. 08/851,982, filed May 6, 1997, entitled “Speaker Recognition Over Large Population With fast and Detailed Matches,” U.S. patent application Ser. No. 08/787,029, filed Jan. 28, 1997, entitled “Speaker Model Prefetching,” each assigned to the assignee of the present invention and incorporated by reference herein.

The request for a special sample can include coordinates of portions of a biometric that are represented as a domain in a multi-dimensional vector space. For example, a request for a fingerprint sampling from the fingerprint 300 of FIG. 3A, is represented as four coordinates of centers of squares 301-304. The size of each square 301-304 can also be included in the request. Another example of a request are coordinates of one or more pixels in a biometric that is represented as a domain in a multi-dimensional vector space. For example, as previously indicated, coordinates can be dynamically chosen as pixels in some facial area, for example, that covers an eye or hairs. The content of such a pixel is a color of the coordinate point that represents eye or hair color.

In addition, the biometric security system 180 can request a set of phones from a spoken phrase. For example, if a user password is a spoken phrase, the speech content corresponding to phones can be used to verify the identity of the user. The speech content can be represented, for example, as PCM or cepstral segments corresponding to time intervals for these phones. These time intervals can be identified using speech alignment techniques, such as those described in F Jelenek, “Statistical Methods for Speech Recognition,” (MIT Press, Massachusetts, 1998) or using a ballistic labeler, such as the one described in U.S. patent application Ser. No. 09/015,150, filed Jan. 29, 1998, entitled “Apparatus and Method for Generating Phonetic Transcriptions From Enrollment Utterances,” each incorporated by reference herein.

In a further variation, the biometric security system 180 can request speech data segments using a set of sub-phones, phones or classes of phones. Image biometric portions can be requested, for example, as coordinates of fingerprint sub-areas, coordinates of pixels of fingerprints, coordinates of facial sub-areas, coordinates of pixels of a facial area, coordinates of eye sub-areas, coordinates of pixels of an eye area. Similarly, requests for gesture samples can be obtained by sending time moments indicating when the gesture samples should be taken For a discussion of a system for performing a multimedia (audio-video) user recognition, see, for example, U.S. patent application Ser. No. 09/369,706, filed Aug. 6, 1999, entitled “Methods and Apparatus for Audio-Visual Speaker Recognition and Utterance Verification,” assigned to the assignee of the present invention and incorporated by reference herein

### Integration of Received Packets at Destination

FIG. 5 illustrates a biometric integrator 500 that may be used by the destination server 115-2 (or the central biometric security system 180) to reintegrate the received biometric packets. As shown in FIG. 5, the integrator 500 includes a time constraint module 510 that specifies how long to wait until all the packets arrive. For example, if the secure service, device or facility has some limits on user waiting time, then the biometrics packets that have arrived may be processed. The received packets are integrated by the integrator 500 and the central biometric security system 180 processes whatever biometrics data is received. The processing of partial biometrics data was fully described in U.S. patent application Ser. No. 09/467,581, filed Dec. 20, 1999, entitled “Methods and Apparatus for Restricting Access of a User Using Random Partial Biometrics,” incorporated by reference above.

As shown in FIG. 5, the biometric integrator 500 also includes a reliability estimator 520 that verifies the reliability of the user verification/authentication using partial biometrics data Generally, if there is a good match of received partial biometrics data with stored biometrics prototypes than the user is granted access. If the mismatch between the received biometrics portions and the stored biometrics prototypes exceeds some predefined threshold then the user is denied access to the requested service, device or facility. Otherwise, the system waits for any remaining packets to arrive or requests more biometrics screening data from the biometric sensor unit 140 The biometric integrator 500 may also include a smoothing module (not shown) that extrapolates the lost frames of biometric data. There are many methods for smoothing lost data. One of suitable method is based on spline extrapolation For a discussion of spline extrapolation techniques, see, for example, www.swcp.com/˜larrys/spline_patching_tutorial.htm, incorporated by reference herein.

FIG. 6 illustrates an integrator 600 that may be used by the destination server 115-2 (or the destination packet telephone 130-2) to reintegrate the received voice packets. As shown in FIG. 6, the integrator 600 includes a time constraint module 610 that specifies how long to wait until all the packets arrive. The received packets are integrated by the integrator 600 and the packet telephone 130-2 processes whatever voice data is received

As shown in FIG. 6, the integrator 600 also includes a smoothing module 620 that extrapolates the lost frames of voice data. There are many methods for smoothing lost data. One of suitable method is based on spline extrapolation For a discussion of spline extrapolation techniques, see, for example, www.swcp.com/˜larrys/spline_patching_tutorial.htm, incorporated by reference herein. The integrated and smoothed voice data is uncompressed to an audio signal that is sent to the packet telephone 130-2.

### Processes

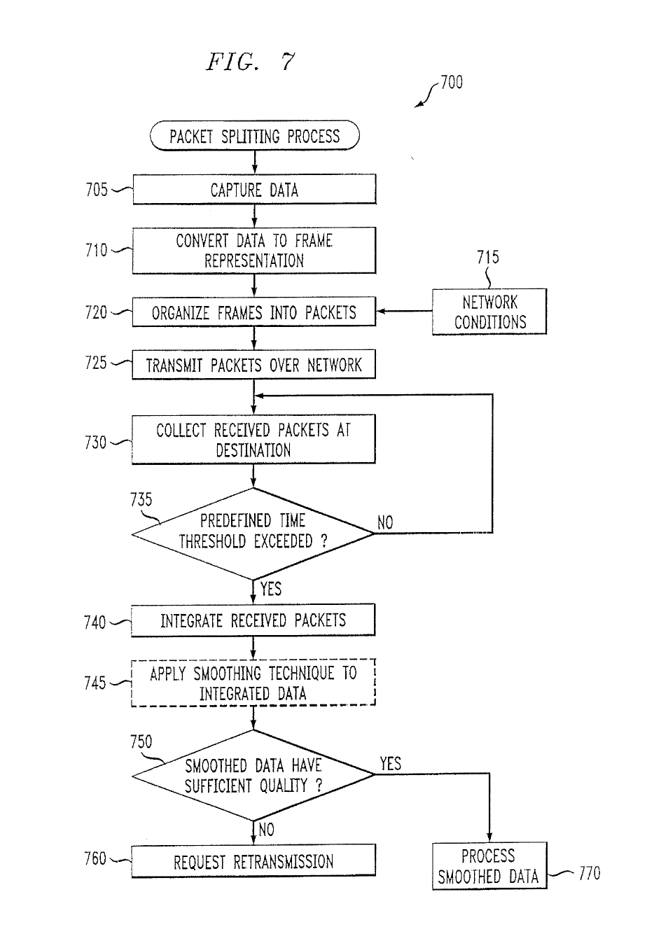

FIG. 7 is a flow chart describing an implementation of the present invention from a process point of view. As shown in FIG. 7, the data is initially captured during step 705. The data is then converted into a frame representation during step 710. The frames are then organized into packets during step 720, depending on the content of the data and the current network load (as determined during step 715).

The packet data is then transmitted over the network 110 during step 725. The received packets are collected at the destination during step 730. The time constraint module 510, 610 determines when the predefined time threshold is exceeded during step 735 Once the predefined time threshold is exceeded, the received packets are integrated into the whole data during step 740.

Thereafter, a smoothing algorithm, if available, is applied to the integrated data, if necessary, during step 745. The quality of the smoothed data is evaluated during step 750. If it is determined during step 750 that the smoothed data has insufficient quality for further processing, then retransmission of the data is requested during step 760

If however, it is determined during step 750 that the smoothed data has sufficient quality for further processing, then the smoothed data is processed during step 770, without requesting retransmission.

It is to be understood that the embodiments and variations shown and described herein are merely illustrative of the principles of this invention and that various modifications may be implemented by those skilled in the art without departing from the scope and spirit of the invention.

What is claimed is:

1. A method for transmitting biometric data in a network, comprising the steps of:
obtaining biometric information for a user;
obtaining N biometric portions from said biometric information, wherein N>1 and wherein between 1 and N−1 of said N biometric portions are sufficient to identify or verify said user; and
transmitting between 2 and N of said biometric portions to a destination using a plurality of packets.

2. The method of claim 1, wherein said user is provided access to a requested device, service or facility if said received biometric portions match corresponding biometric prototype portions.

3. The method of claim 1, wherein said biometric information comprises one or more of a biometric image and speech segments

4. A method for transmitting data in a packet network, comprising the steps of:
obtaining at least two packets of data for transmission, wherein said data comprises between 2 and N biometric portions of biometric information, wherein N>1, and wherein between 1 and N−1 of said N biometric portions are sufficient to identity or verify said user;
interchanging said data from said at least two packets to obtain at least two interchanged packets; and
transmitting said interchanged packets to a destination.

5. The method of claim 4, wherein said interchanging step further comprises the steps of placing odd numbered frames from said at least two packets into a first interchanged packet and even numbered frames from said at least two packets into a second interchanged packet

6. The method of claim 4, wherein said interchanging step generates M interchanged packets and wherein said method further comprises the steps of placing every Nth frame in a given interchanged packet.

7. The method of claim 4, wherein said user is provided access to a requested device, service or facility if said received biometric portions match corresponding biometric prototype portions.

8. The method of claim 4, wherein said biometric information comprises one or more of a biometric image and speech segments.

9. A method for transmitting data in a packet network, comprising the steps of:
obtaining frames of data for transmission, wherein said data comprises between 2 and N biometric portions of biometric information, wherein N>1, and wherein between 1 and N−1 of said biometric portions are sufficient to identify or verify said user;
generating M interchanged packets by placing every Mth frame of data in a given interchanged packet; and
transmitting said interchanged packets to a destination.

10. The method of claim 9, wherein said frames of data includes biometric information.

11. The method of claim 9, wherein said user is provided access to a requested device, service or facility if said received biometric portions match corresponding biometric prototype portions

12. The method of claim 9, wherein said biometric information comprises one or more of a biometric image and speech segments.

13. A system for transmitting biometric data in a network, comprising:
a memory that stores computer-readable code; and
a processor operatively coupled to said memory, said processor configured to implement said computer-readable code, said computer-readable code configured to:
obtain biometric information for a user;
obtain N biometric portions from said biometric information, wherein N>1 and wherein between 1 and N−1 of said N biometric portions are sufficient to identify or verify said user; and
transmit said between 2 and N biometric portions to a destination using a plurality of packets

14. The system of claim 13, wherein said user is provided access to a requested device, service or facility if said received biometric portions match corresponding biometric prototype portions

15. The system of claim 13, wherein said biometric information comprises one or more of a biometric image and speech segments.

16. A system for transmitting data in a packet network, comprising:
a memory that stores computer-readable code; and
a processor operatively coupled to said memory, said processor configured to implement said computer-readable code, said computer-readable code configured to:
obtain at least two packets of data for transmission, wherein said data comprises between 2 and N biometric portions of biometric information, wherein N>1, and wherein between 1 and N−1 of said biometric portions are sufficient to identify or verify said user;
interchange said data from said at least two packets to obtain at least two interchanged packets; and
transmit said interchanged packets to a destination

17. A system for transmitting data in a packet network, comprising:
a memory that stores computer-readable code; and
a processor operatively coupled to said memory, said processor configured to implement said computer-readable code, said computer-readable code configured to:
obtain frames of data for transmission, wherein said data comprises between 2 and N biometric portions of biometric information, wherein N>1, and wherein between 1 and N−1 of said biometric portions are sufficient to identify or verify said user;
generate M interchanged packets by placing every Mth frame of data in a given interchanged packet; and
transmit said interchanged packets to a destination
